(19) United States
(12) Patent Application Publication
(10) Pub. No.: US 2008/0196706 A1
(43) Pub. Date: Aug. 21, 2008

(54) APPARATUS FOR CUTTING STONE

(76) Inventor: Triston Fowler, Inkom, ID (US)

Correspondence Address: MADSON & AUSTIN, 15 WEST SOUTH TEMPLE, SUITE 900, SALT LAKE CITY, UT, 84101, US

(21) Appl. No.: 12/034,450

(22) Filed: Feb. 20, 2008

Related U.S. Application Data
(60) Provisional application No. 60/890,760, filed on Feb. 20, 2007.

(51) Int. Cl. B28D 1/32

(52) U.S. Cl. 125/23.01

(57) ABSTRACT

An apparatus for cutting stone is described. The apparatus may include a structural member. The apparatus may include a first chisel. The first chisel may be rigidly connected to the structural member. The first chisel may include a tip. The apparatus may include a second chisel. The second chisel may be moveable with respect to the first chisel. The second chisel may include a tip. The second chisel may be configured to move from a first position to a second position. The first chisel and the second chisel may be oriented within approximately the same plane.

### CROSS-REFERENCED RELATED APPLICATIONS

This application claims the benefit of U.S. Provisional Application No. 60/890,760 filed Feb. 20, 2007. This prior patent application is expressly incorporated herein by reference.

### BACKGROUND OF THE INVENTION

The demand for stonework has increased in recent years as consumers have desired stone countertops in restaurants, offices, homes, and other locations. Consumers typically prefer natural granite, bluestone, slate, limestone, and marble (or other natural stones) for stonework to maintain architectural design and aesthetically pleasing structures. (Granite countertops are particularly popular for interior decor). Accordingly, countertops made of granite, slate, marble, etc. are routinely used in many construction and remodeling projects.

As the demand for stonework has increased, the desire for more customized stonework has also grown. Customized stonework generally requires an artist's skill and mastery to make the countertop look desirable. For example, many consumers desire a rough cut edge on the stonework, as opposed to a manufactured, straight edge that is sold and shipped to the jobsite. Accordingly, if a customer wants a “customized,” rough edge, this straight edge must be cut into the desired form by the installer.

However, custom rough cut stone typically requires on site customizations, consulting, manpower, expertise, and time. Most customized rough edges are produced using standard hammer and chisel techniques—i.e., hammering and/or chiseling the stone into the desired shape). Of course, such standard hammer and chisel solutions typically require experienced stoneworkers, which may increase the cost of the project. Such hammer and chisel techniques also may also increase the time required to install the countertop. Further, adding this rough edge to the stone increases the difficulty of the project. If a careless hammer and chisel stroke is performed, the entire stone slab may be ruined. Care and precision must be used to achieve the desired rough cut stonework.

Therefore, a need exists for an apparatus for cutting stone that may be use by less experienced stoneworkers. This apparatus is disclosed herein. Particularly, the present apparatus may be suitable for adding a rough edge to a stone countertop and/or cutting stone.

### BRIEF SUMMARY OF THE INVENTION

An apparatus for cutting stone is described. The apparatus includes a structural member. The apparatus also includes a first chisel that is connected (or rigidly connected) to the structural member. The first chisel includes a tip. The apparatus includes a second chisel. The second chisel is moveable with respect to the first chisel. The second chisel also includes a tip. The second chisel is configured to move from a first position to a second position. The first chisel and the second chisel are oriented within approximately the same plane.

In some embodiments, the apparatus includes a cylinder apparatus that is connected to the structural member. In further embodiments, the second chisel is connected to the cylinder apparatus. In still further embodiments, the tips of the first and second chisels are carbide tips. The tips of the first and second chisels may be removable.

In some embodiments, in the first position, the tip of the first chisel is a first distance away from the tip of the second chisel, and in the second position, the tip of the first chisel is a second distance away from the tip of the second chisel. In further embodiments, the second distance is shorter than the first distance. In still further embodiments, the second distance is about one half (½) inch.

In some embodiments, the cylinder apparatus is a hydraulic cylinder apparatus that is in fluid communication with a hydraulic pump. In other embodiments, the cylinder apparatus uses a power source. The power source may or may not be a pneumatic power source. In further embodiments, the cylinder apparatus is at least a five ton ram. In still further embodiments, the hydraulic pump is a ¾ horsepower hydraulic pump. In some embodiments, the apparatus has sufficient power to cut stone of a thickness greater than one half inch.

In some embodiments, the hydraulic cylinder apparatus is a spring return cylinder. In still further embodiments, the second chisel may be removeably connected to the cylinder apparatus. This removable connection may be accomplished by having the second chisel include threads that screw into the cylinder apparatus.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a partially cutaway perspective view of an embodiment of a system for cutting stone shown in a first position;

FIG. 2 is a perspective view of the embodiment of FIG. 1 shown in a second position;

FIG. 3 is a perspective view of the embodiment of FIG. 1 prior to cutting a piece (or slab) of stone; and

FIG. 4 is a perspective view of the embodiment of FIG. 1 after cutting a piece of stone.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

The word “exemplary” is used herein to mean “serving as an example, instance, or illustration.” Any embodiment described herein as “exemplary” is not necessarily to be construed as preferred or advantageous over other embodiments.

As used herein, the terms “an embodiment”, “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments of the disclosed invention(s),” unless expressly specified otherwise.

FIG. 1 is an embodiment of a system 100 for cutting stone shown in a first position. (For clarity, FIG. 1 is a partially cutaway perspective view of the system 100). The system 100 includes a structural member 102, a first chisel 110, a second chisel 120, a cylinder assembly 130, and a power source 140. The first chisel 110 may be rigidly connected to the structural member 102. In some embodiments, the structural member 102 may be a “C-Clamp” that may or may not be modified to receive the chisels 110, 120. Suitable “C-clamps” are commercially available from a variety of sources, such as the Enerpac® brand products sold by the Applied Power Inc, corporation of Milwaukee, Wis. Of course, this is just an example of the type of C-clamp that may be used. Other c-clamps, or other types of devices, may be used as the structural member 102.

In the present embodiment, the second chisel 120 is connected to the cylinder assembly 130. The cylinder assembly 130 may include a piston 170. The piston 170 may be housed within the cylinder assembly 130 and may contact a bottom portion 120a of the chisel 120. More specifically, the cylinder assembly 130 includes a piston 170 that is housed within a chamber 171. The piston 170 is moveable within the chamber 171. The cylinder assembly 130 is connected to the structural member 102. For example, the cylinder assembly 130 and the structural member 102 may be threaded such that the cylinder assembly 130 screws into the structural member 102. Other methods of connecting the structural member to the cylinder assembly 130 may also be used. A spring return 176 is also added (as will be described herein).

The second chisel 120 may also be threaded such that the chisel 130 may be screwed into the cylinder assembly 130. For example, the second chisel 120 may be screwed into the piston 170 of the cylinder assembly 130. In some embodiments, the first chisel 110 may be threaded and/or may be movable with respect to the apparatus 102. Other methods for connecting the first chisel 110 and/or the second chisel 120 to either the cylinder assembly 130 or the structural member 102 may be used, as desired.

The first chisel 110 may include a tip 114. The second chisel 120 may also include a tip 124. The tips 114, 124 may include a carbide coating, a carbide insert, and/or other materials and/or tips that may provide sufficient strength to cut stone. (Other materials may also be used but such materials may wear out sooner). In some embodiments, the tips 114, 124 may be removable. Those skilled in the art will appreciate how to make the tips 114, 124 removable and/or will appreciate how other materials may be used to construct the tips 114, 124.

A variety of different types of chisels may be used as the chisels 110, 120 including commercially available “hand tool” chisels. One type of chisel currently used is a “Carbide Hand Tracer” chisel that is commercially available. Similarly, custom-made or designed chisels may be used. However, to perform optimal cutting, the angle of the chisel head should be straight to provide the appropriate cut. As explained herein, the chisels 110, 120 may be screwed into the structural member 102 and/or the cylinder apparatus 130. Specifically, a hand tool chisel may be obtained and “machined” or modified so that it may be screwed into the structural member 102 and/or the cylinder apparatus 130.

The first chisel 110 and the second chisel 120 may be oriented such that the chisels 110, 120 are within approximately the same plane. In some embodiments, this may be accomplished by configuring the chisels 110, 120 such that they are parallel or substantially parallel, when positioned on the structural member 102. Orienting the chisels 110, 120 within approximately the same plane may facilitate cleaner cuts than chisels that are not oriented within approximately the same plane. As shown in FIG. 1, in the first position the chisels 110, 120 may be separated by a first distance 126.

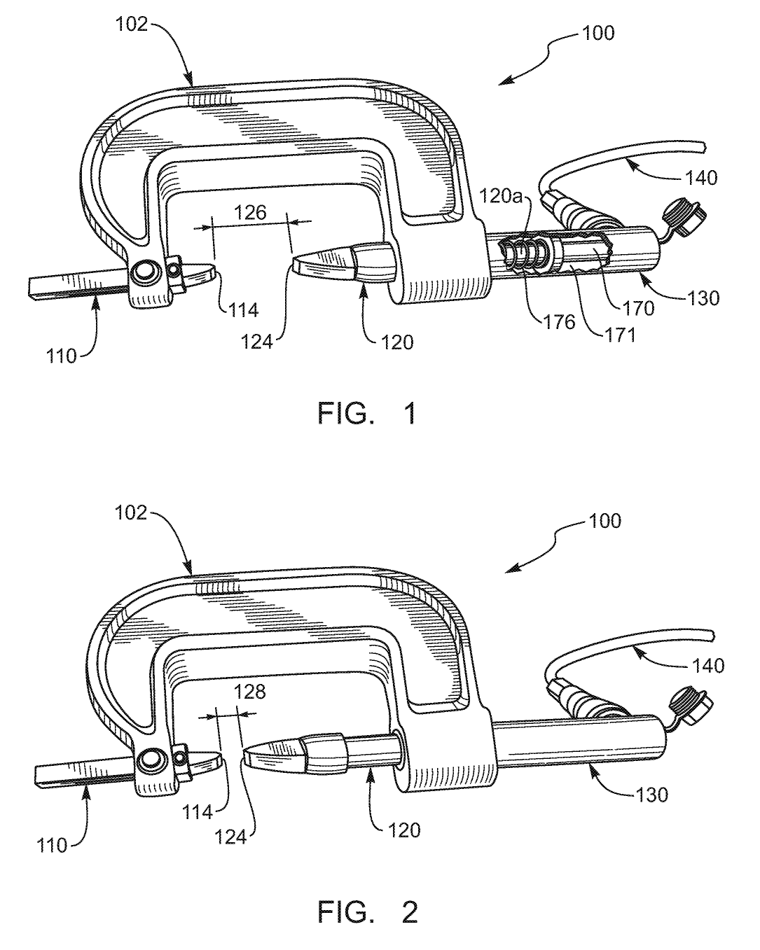

FIG. 2 is the embodiment of FIG. 1 of a system 100 for cutting stone shown in a second position. The second chisel 120 is moveable toward the first chisel 110. In the second position the chisels 110, 120 may be separated by a second distance 128. In some embodiments, the second distance 128 may be smaller than the first distance 126 of FIG. 1. In the present embodiment, the second distance 128 may be about one half inch. In other words, the tips must be relatively close so that the stone will be cut.

The second distance 128 may be adjustable. For example, the second distance 128 may be predetermined by the user and may be adjusted such that the second distance 128 may be larger or smaller. The second distance 128 may be varied by adjusting the position of the first chisel 110 and/or the second chisel 120. In some embodiments, the second position may be set such that when the second chisel 120 is moved into the second position, a slab of stone may be completely cut.

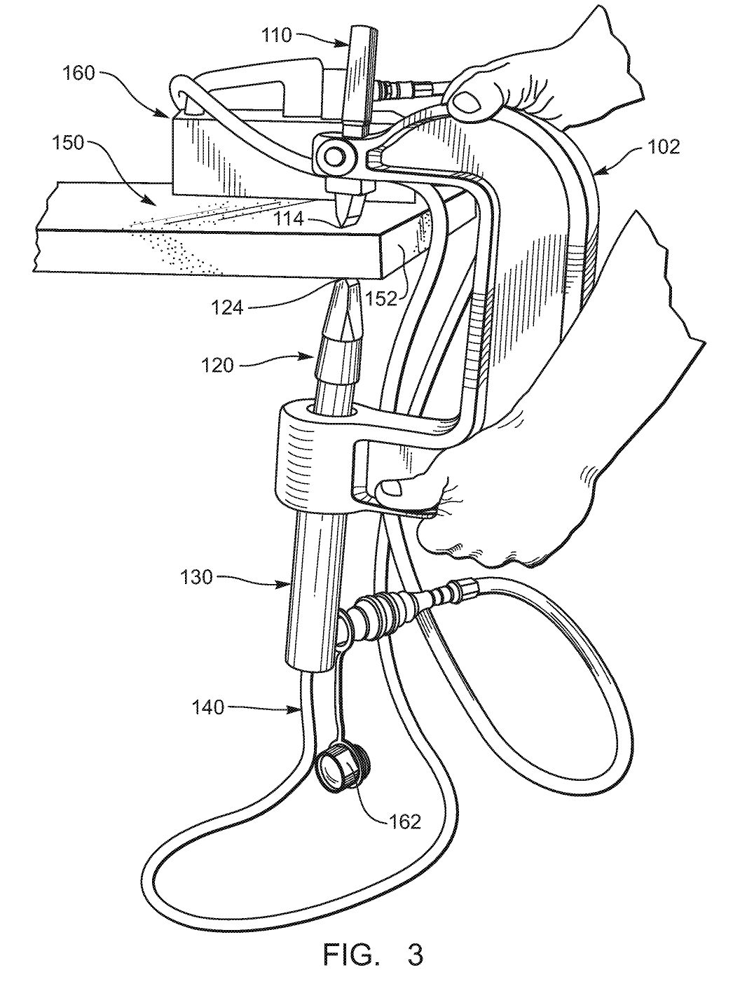

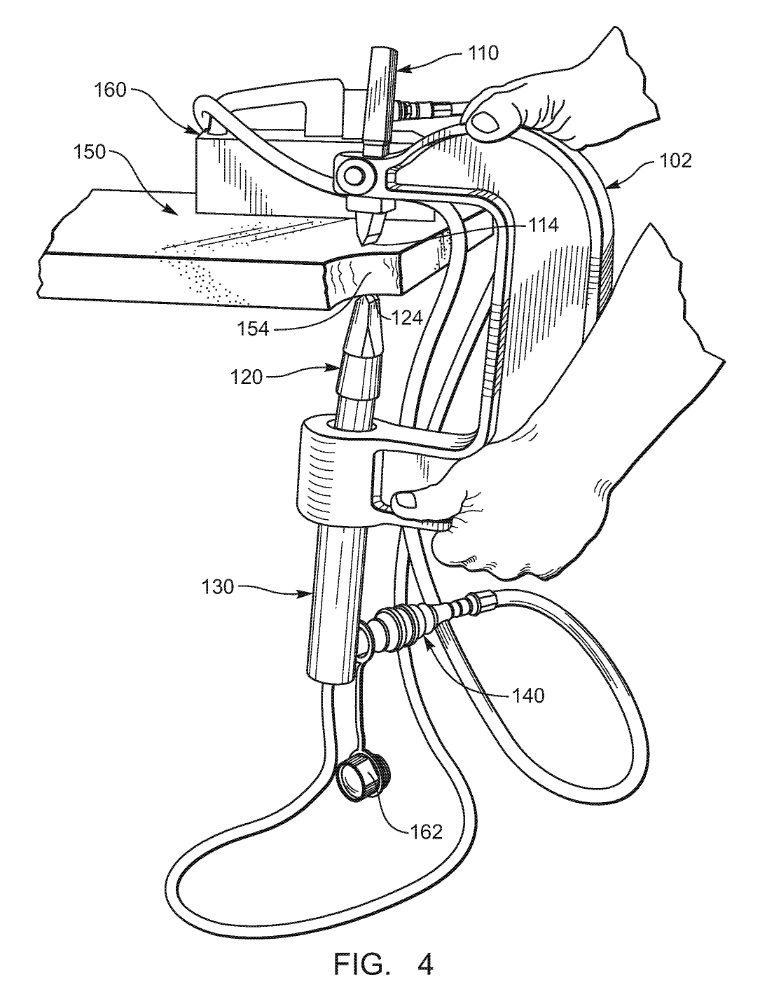

In the present embodiment, the second chisel 120 may be moved by the cylinder assembly 130. In other embodiments, other devices may be used to move the second chisel 120 toward the first chisel 110. Any type of mechanism or means capable of moving the second chisel 120 toward the first chisel 110 may be used. In the present embodiment, the cylinder assembly 130 may be a hydraulic cylinder and the power source 140 may be a hydraulic line. As shown in FIGS. 3 and 4, the cylinder assembly 130 may be in fluid communication with a pump 160 via the power source 140. In some embodiments, the pump 160 is a hydraulic pump. In other words, the hydraulic pump 160 supplies a quantity of hydraulic fluid that operates to move the piston 170 (shown in FIG. 1). In turn, this movement of the piston 170 moves the second chisel 120 closer to the first chisel 110 and operates to cut the stone.

In other embodiments, the pump 160 may be omitted and the power source 140 may only be used to move the second chisel 120. In other words, the cylinder assembly 130 may be electrically actuated and the power source 140 may be an electrical source. The electrical power from the power source 140 operates to move the piston 170, and may cause the second chisel to move closer to the first chisel 110.

In some embodiments, the second chisel 120 may be moved in response to a button or actuator. The button or actuator may be located on the apparatus 102 and/or on the power source 140. For example, the button or actuator may be located on the pump 160.

Those skilled in the art will appreciate that there are a variety of different ways of driving the piston as a means of supplying the force necessary to cut the stone. This may include the use of electrical motors, etc. All such mechanisms may be used and are within the scope of the present embodiments.

Embodiments where the cylinder assembly 130 is a hydraulic cylinder and is in fluid communication with a pump 160 that is also a hydraulic, may provide the advantage of reducing the size of the system without sacrificing power. Accordingly, such a use of hydraulics may be beneficial as compared to a pneumatic cylinder assembly and pneumatic pump. Use of a pneumatic cylinder assembly and pneumatic pump typically results in a large and cumbersome system. The generally increased size and bulky nature of a pneumatic system may make job site preparations more time consuming and therefore more costly. Of course, the use of a pneumatic device and/or pneumatic pump may be desirable in other embodiments.

In some embodiments, the apparatus may have sufficient power to cut stone of a thickness greater than one half inch. In other embodiments, the apparatus may have sufficient power to cut stones of a thickness greater than four inches. In further embodiments, the cylinder assembly 130 may include a five ton ram. Other sizes may be used. (However, those skilled in the art will recognize that if the ram is “too small,” the device may struggle in cutting the stone). In still further embodiments, the pump 160 may be a three-quarter horsepower (¾ horsepower) hydraulic pump. (Other sizes, such as a ½ horsepower or 1 horsepower pump may also be used). An example of this type of pump is the commercially available ¾ horsepower “Quarter Horse®” pump that is produced by the SPX Corporation (which is sometimes referred to as SPX dba Power Team) of Charlotte, N.C. Suitable pumps available from this company may have up to 25 horsepower. Of course, this type of pump is given for exemplary purposes only. Other types of pumps and/or pumps made by other suppliers may also be used.

Likewise, a example of the type of cylinder assembly 130 that may be used is a single acting cylinder that is available under the “Enerpac”® trademark of the Applied Power corporation of Milwaukee, Wis. These types of cylinders are hydraulic piston-containing cylinders that may be attached to a pump and used to selectively deploy the piston. Such cylinders are appropriate for the present embodiments. Of course, other types of cylinders may also be used, including those cylinders provided by a different supplier.

FIGS. 3 and 4 illustrate the embodiment of a system 100 for cutting stone of FIG. 1 prior to cutting a slab of stone 150 and after cutting the slab of stone 150 respectively. As can be seen in FIGS. 3 and 4, the slab of stone 150 may have a straight edge 152 prior to cutting. This straight edge was manufactured and many customers find that the “look and feel” of this straight edge is unsatisfactory. However, after the slab of stone has been cut, using the system 100, a rough edge 154 is produced. Many customers appreciate the “look and feel” of this rough edge 154.

It should be noted that the stone shown in FIGS. 3 and 4 is a “slab” or flat piece of stone. Of course, this depiction is made for illustrative purposes only. Stones of other shapes may also be cut using the present system 100. Likewise, stones of varying thickness may be cut using the system 100. For example, a slab of stone that is 4 inches thick may be cut (or any other thickness), depending upon the embodiment. Slabs of stone as thin as ¾ inch may be cut as well. One of the advantages of the present devices is that, by using power and larger power supplies, stones of greater thickness may be cut. Accordingly, if a stone of increased thickness is going to be cut, a larger power supply may be required. This is an advantage to other types of devices that can only struggle to cut stones of larger thickness or require large, bulky pneumatic power supplies to cut large stones.

As shown in FIG. 3, one advantage of the present embodiment is that a user may be able to use the apparatus by hand. For example, the user may rest the first chisel 110 against the stone 150 to be cut. Likewise, the pump 160 may rest on top of the slab of stone 150 for ease and convenience during the cutting process. The second chisel 120 is positioned below the stone 150 and is raised to perform the cutting process. When moved into position, the second chisel 120 and the first chisel 110 create a “pinch point” or point of tension on the stone that breaks/cuts the stone.

In the present embodiment, the hydraulic pump 160 may communicate hydraulic fluid through the power source 140 to the cylinder assembly 130, which moves the second chisel 120 toward the first chisel 110 such that the tips 114, 124 of the chisels 110, 120 are only separated by the second distance 128 in the second position, as shown in FIG. 2. (More specifically, the fluid moves the piston 170 (not shown in FIGS. 3 or 4), which in turn, moves the second chisel 120.) When the second chisel 120 reaches the second position, the tips 114, 124 of the chisels 110, 120 may cut the stone 150 leaving a rough cut edge 154, as shown in FIG. 4.

A cap 162 may also be added the cylindrical assembly 130 for when the system 100 is not in use—i.e., the system 100 is not connected to the pump 160. This cap 162 prevents any fluid that is within the cylindrical assembly 130 from leaking out and causing a mess. Threads may be used to removeably secure this cap 162 to the cylindrical assembly 130. These same threads may also be used to connect the pump 160 when in use.

The cylinder assembly 130, in the present embodiment, may include a spring return 176 (shown in FIG. 1). (In other words, the cylinder may be a “spring return” cylinder). The spring return may move the second chisel 120 from the second position, shown in FIG. 2, to the first position, shown in FIG. 1. In other embodiments, the cylinder assembly 130 may be a dual action cylinder and the hydraulic pump 160 may be a dual action pump such that the cylinder assembly 130 moves the second chisel 120 from the second position to the first position and from the first position to the second position by the cylinder assembly 130 and pump 160 without springs and/or other assistance. Those skilled in the art will appreciate that there are a variety of different means and mechanism, which may or may not include a spring return 176, that are designed to return the second chisel 120 from the second position to the first position, so that the system 100 may be re-used to cut a different portion of the stone. Some of these methods include a “hydraulic return” cylinder, etc. Any and all of these mechanisms are within the scope of the present invention. Those skilled in the art would appreciate how such a mechanism could be implemented and used.

As shown in FIG. 4, the system 100 has been used to create a rough edge 154 proximate a corner of the slab of stone 150. This same cutting procedure may then be repeated, as desired, to add additional rough edges 154. Typically, this may involve adding a rough edge 154 along the entire edge of the slab of stone 150. It should be noted that creating the rough edge 154 using the system 100 still allows the worker to add an “artist's touch” or artistic element to the stone. In fact, the worker can cut the stone in any way s/he desires to make the stone attractive. The system 100 provides an easier mechanism for cutting the stone, thereby making the worker's job easier.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An apparatus for cutting stone, comprising:
a structural member;
a first chisel connected to the structural member, the first chisel comprising a tip;
a second chisel moveable with respect to the first chisel, the second chisel comprising a tip, wherein the second chisel is moveable from a first position to a second position; and
wherein the first chisel and the second chisel are oriented within approximately the same plane.

2. The apparatus of claim 1, further comprising a cylinder apparatus connected to the structural member, wherein the second chisel is connected to the cylinder apparatus.

3. The apparatus of claim 1, wherein the tips of the first and second chisels are carbide tips.

4. The apparatus of claim 2, wherein the cylinder apparatus is a hydraulic cylinder apparatus and the hydraulic cylinder is in fluid communication with a hydraulic pump.

5. The apparatus of claim 4, wherein the hydraulic pump comprises a ¾ horsepower hydraulic pump.

6. The apparatus of claim 1, wherein in the first position, the tip of the first chisel is a first distance away from the tip of the second chisel, wherein in the second position, the tip of the first chisel is a second distance away from the tip of the second chisel, and wherein the second distance is shorter than the first distance.

7. The apparatus of claim 6, wherein the second distance is about one half inch.

8. The apparatus of claim 2, wherein the cylinder apparatus comprises a spring that operates to return the second chisel from the second position to the first position.

9. The apparatus of claim 2, wherein the second chisel further is removeably connected to the cylinder apparatus.

11. The apparatus of claim 2, wherein the cylinder apparatus is connected to a power source.

12. The apparatus of claim 1, wherein the apparatus has sufficient power to cut stone of a thickness greater than one half inch.

13. The apparatus of claim 1, wherein the first chisel is rigidly connected to the structural member.

14. An apparatus for cutting stone, comprising:
a structural member;
a first chisel rigidly connected to the structural member, the first chisel comprising a tip;
a second chisel moveable with respect to the first chisel, the second chisel comprising a tip, wherein the second chisel is moveable from a first position to a second position, the first chisel and the second chisel being oriented within approximately the same plane
a cylinder apparatus connected to the structural member, the cylinder apparatus comprising a moveable piston, wherein the second chisel is connected to the piston; and
a spring capable of returning the second chisel from the second position back to the first position.
